(19) United States
(12) Patent Application Publication
(10) Pub. No.: US 2008/0251487 A1
(43) Pub. Date: Oct. 16, 2008

(54) OVERMOLDED CONTAINER HAVING A FOAM LAYER

(76) Inventors: Frank E. Semersky, Holland, OH (US); William D. Voyles, Toledo, OH (US)

Correspondence Address: FRASER CLEMENS MARTIN & MILLER LLC, 28366 KENSINGTON LANE, PERRYSBURG, OH, 43551, US

(21) Appl. No.: 12/144,885

(22) Filed: Jun. 24, 2008

Related U.S. Application Data
(63) Continuation-in-part of application No. 11/015,360, filed on Dec. 17, 2004.
Application No. 11/015,360 is a continuation-in-part of application No. 10/684,611, filed on Oct. 14, 2003.
(60) Provisional application No. 60/545,049, filed on Feb. 17, 2004.
(60) Provisional application No. 60/422,223, filed on Oct. 30, 2002.

(51) Int. Cl. B65D 23/08; B29C 49/22

(52) U.S. Cl. 215/12.1; 428/36.5; 264/537

(57) ABSTRACT

An overmolded preform and a container blow molded from the same are disclosed, wherein the overmolded preform and the overmolded container include an outer foamed layer.

### CROSS-REFERENCE TO RELATED APPLICATION

This application is a continuation-in-part of U.S. patent application Ser. No. 11/015,360 filed on Dec. 17, 2004, hereby incorporated herein in its entirety, which claims the benefit of U.S. Provisional Patent Application Ser. No. 60/545,049, filed on Feb. 17, 2004, hereby incorporated herein by reference in its entirety, and a continuation-in-part of U.S. patent application Ser. No. 10/684,611 filed Oct. 14, 2003, hereby incorporated herein by reference in its entirety, which claims the benefit of U.S. Provisional Patent Application Ser. No. 60/422,223, filed on Oct. 30, 2002, hereby incorporated herein by reference in its entirety.

### FIELD OF THE INVENTION

The present invention relates generally to a plastic container having a foam layer. More particularly, the invention is directed to an overmolded multi-layered plastic container including at least one layer of foam wherein the foam cells contain carbon dioxide or nitrogen.

### BACKGROUND OF THE INVENTION

Biaxially oriented multi-layered bottles may be manufactured from plastic materials such as, for example, polyethylene terephthalate (PET) using a hot preform process, wherein a multi-layered perform is heated to its desired orientation temperature and drawn and blown into conformity with a surrounding mold cavity. The multi-layered preform may be prepared by any conventional process such as, for example, by coinjecting a preform comprising multiple layers of plastic or by injecting subsequent layers of plastic over a previously injection molded preform. Generally, multiple layers are used for food or carbonated beverage containers, to improve the oxygen or carbon dioxide diffusion barrier properties of the overall package.

The various layers of plastics in the prior art multi-layered containers are generally in intimate contact with one another, thereby facilitating the conduction of thermal energy through the walls of the containers. This allows the chilled contents of the container to quickly warm to the ambient temperature. Accordingly, such containers are often sheathed in, for example, a foamed polystyrene shell to impart thermal insulating properties to the container.

It would be desirable to prepare a multi-layered container having improved thermal insulating properties.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a cross-sectional view of an overmolded thermoplastic polymer preform according to an embodiment of the invention;

FIG. 2 is a cross-sectional view of an embodiment of a non-foamed preform adapted to be overmolded;

FIG. 3 is a cross-sectional view of an overmolded container formed from the overmolded preform of FIG. 1 according to an embodiment of the invention; and

FIG. 4 is a schematic illustration of a process for preparing the overmolded preform of FIG. 1 and the overmolded container of FIG. 3 according to another embodiment of the invention.

### SUMMARY OF THE INVENTION

Concordant and congruous with the present invention, an overmolded container exhibiting the properties set forth above has surprisingly been discovered. The overmolded container comprises: a first layer of plastic; and a second layer of plastic contacting the first layer, the second layer of plastic formed as a foam.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

An embodiment of the invention is directed to a container comprising a first layer of plastic and a second layer of plastic contacting said first layer, said second layer of plastic formed as a foam wherein the foam cells contain carbon dioxide or nitrogen.

The first and second layers of plastic may be the same or different, in composition, thickness, orientation, etc. Furthermore, the invention contemplates a container having any number (greater than one) of layers of plastics, as long as at least one of the plastic layers comprises a foam. Moreover, the invention contemplates the use of a cellular foam plastic layer wherein the foam cells contain not only carbon dioxide, but also one or more other gasses.

Suitable plastics from which the first and/or second plastic layers may be prepared include, but are not necessarily limited to, polyesters, acrylonitrile acid esters, vinyl chlorides, polyolefins, polyamides, and the like, as well as derivatives, blends, and copolymers thereof. A preferred plastic for one or both of the plastic layers is PET.

In addition to carbon dioxide, the foam cells may contain other gases typically used in processes for making cellular foam structures, including nitrogen, argon, and the like. Preferably, the amount of carbon dioxide present in the foam cells will be from about four percent to about eight percent by weight and possibly up to ten percent by weight. The foam layer acts as an effective thermal insulator, to retard the conduction of heat energy from the atmosphere to the chilled beverage within the container.

The multi-layered container may be produced from a multi-layered preform, by conventional blow molding techniques. The cellular foam plastic layer may be prepared coextensively with the other plastic layer by, for example, a coextrusion process, or the first plastic layer may be applied to or received by the foam plastic layer in a multi-step injection molding process.

To prepare the preform, polymer flakes are melted in a conventional plasticizing screw extruder, to prepare a homogeneous stream of hot polymer melt at the extruder discharge. Typically, the temperature of the polymer melt stream discharged from the extruder ranges from about 225 degrees Centigrade to about 325 degrees Centigrade. One ordinarily skilled in the art will appreciate that the temperature of the polymer melt stream will be determined by several factors, including the kind of polymer flakes used, the energy supplied to the extruder screw, etc. As an example, PET is conventionally extruded at a temperature from about 260 degrees Centigrade to about 290 degrees Centigrade. A non-reactive gas is injected under pressure into the extruder mixing zone, to ultimately cause the entrapment of the gas as microcellular voids within the polymer material. By the term “non-reactive gas” as it is used herein is meant a gas that is substantially inert vis-à-vis the polymer. Preferred non-reactive gases comprise carbon dioxide, nitrogen, and argon, as well as mixtures of these gases with each other or with other gasses.

It is well-known that the density of amorphous PET is 1.335 grams per cubic centimeter. It is also known that the density of PET in the melt phase is about 1.200 grams per cubic centimeter. Thus, if the preform injection cavity is filled completely with molten PET and allowed to cool, the resulting preform would not exhibit the proper weight and would have many serious deficiencies, such as sink marks. The prior art injection molding literature teaches that, in order to offset the difference in the densities of amorphous and molten PET, a small amount of polymer material must be added to the part after the cavity has been filled and as the material is cooling. This is called the packing pressure. Thus, about ten percent more material must be added during the packing pressure phase of the injection molding cycle in order to insure that a preform made by injection molding is filled adequately and fully formed. The packing pressure phase of the injection molding operation is likewise used for polymer materials other than PET.

According to the present invention however, the polymer preform is injection molded and simultaneously foamed using a non-reactive gas. The gas is entrained in the material during the injection phase. Contrary to the prior art injection molding process, wherein additional polymer material is injected during the packing phase, the present invention utilizes minimal packing pressure. As the polymer material is still in a molten state, the partial pressure of the non-reactive gas is sufficient to permit the release of the dissolved gas from the polymer into the gas phase where it forms the microcellular foam structure. Thus, the preform made by the inventive process weighs less than, but has the same form and geometry as, the polymer preforms produced by the conventional injection molding operations that employ the packing process.

Upon completion of the injection molding step, the preform is cooled to a temperature below the polymer softening temperature. For example, the softening temperature for PET is approximately 70 degrees Centigrade. Thus, the entrapped non-reactive gas is retained within the walls of the polymer preform. This cooling step is critical to the inventive process, as it conditions the polymer and preserves its desirable properties for the successful preparation of a blow molded container. This cooling step is also necessary when employing polymers such as polyesters, which cannot be blow molded directly from an extruded parison. This cooling step may be effected by any conventional process used in the polymer forming art such as, for example, by passing a stream of a cooling gas over the surfaces of the preform, or cooling the preform while in-mold by cooling the forming mold.

The preform is thereafter reheated to a temperature above the polymer softening temperature. This heating step may be effected by well-known means such as, for example, by exposure of the preform to a hot gas stream, by flame impingement, by exposure to infra-red energy, by passing the preform through a conventional oven, or the like. PET is generally reheated to a temperature twenty to twenty-five degrees above its softening temperature for the subsequent blow molding operation. If PET is reheated too far above its glass transition temperature, or held at a temperature above its softening temperature for an excessive period of time, the PET undesirably will begin to crystallize and turn white. Likewise, if the preform is heated to a temperature above which the mechanical properties of the material are exceeded by the increasing pressure of the non-reactive gas in the microcells, the microcells undesirably will begin to expand thus distorting the preform.

Finally, the preform is blow molded, to prepare a container, consisting essentially of a microcellular foamed polymer having a non-reactive gas contained within the microcellular foam cells. Methods and apparatus for blow molding a container from a polymer preform are well-known.

One ordinarily skilled in the art will readily appreciate that the number and types of plastic layers used, and the various means, chemical and physical, used to produce a foam layer, can be varied over wide limits to produce a variety of contemplated multi-layered containers comprising a first layer of plastic and a second layer of plastic contacting said first layer, said second layer of plastic formed as a foam wherein the foam cells contain carbon dioxide, according to the present invention.

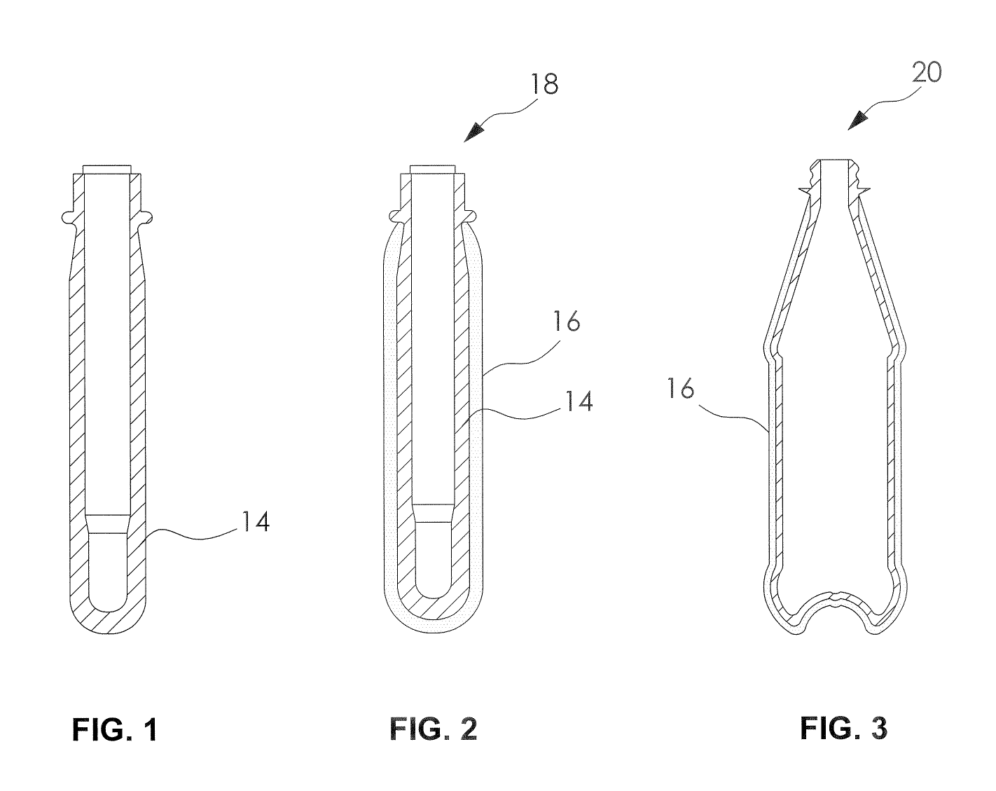

FIG. 2 is an overmolded preform 18 according to an embodiment of the invention. To form the overmolded preform 18, a preform 14 adapted to be overmolded is provided, as shown in FIG. 1. The preform 14 is made by injection molding a plastic material such as, for example, polyethylene terephthalate (PET) using processes and equipment known in the art.

The preform 14 is then overmolded with a foamed material 16 to form the overmolded preform 18. The overmolded preform 18 includes an inner layer formed from the preform 14 and an outer foamed layer formed from the foamed material 16. Suitable plastics from which the foamed material 16 may be prepared include, but are not necessarily limited to, polyesters, acrylonitrile acid esters, vinyl chlorides, polyolefins, polyamides, and the like, as well as derivatives, blends, and copolymers thereof. A preferred plastic for the foamed material 16 is PET. The foamed material 16 may be coextensively formed with the material forming the preform 14 by a coextrusion process, or the foamed material 16 may be applied to or received by the preform 14 by simultaneously injection molding the foamed material 16 and the material forming the preform 14. Alternatively, the foamed material 16 may be formed with preform 14 in a multi-step process such as a multi-step injection molding process. The overmolded preform 18 may be formed in the same mold in which the preform 14 is made by using the multi-step injection molding process, or the preform 14 may be transferred to a second mold for the overmolding step by using an insert molding process. The thickness and surface area of the foamed material 16 overmolded onto the preform 14 will vary based upon design considerations such as cost and a desired appearance of the overmolded container 20.

Next, the overmolded preform 18 is blow molded to form the overmolded container 20 having an outer foamed layer and an inner non-foamed layer, as shown in FIG. 3. The overmolded container 20 may be formed by conventional blow molding techniques, such as reheat stretch blow molding.

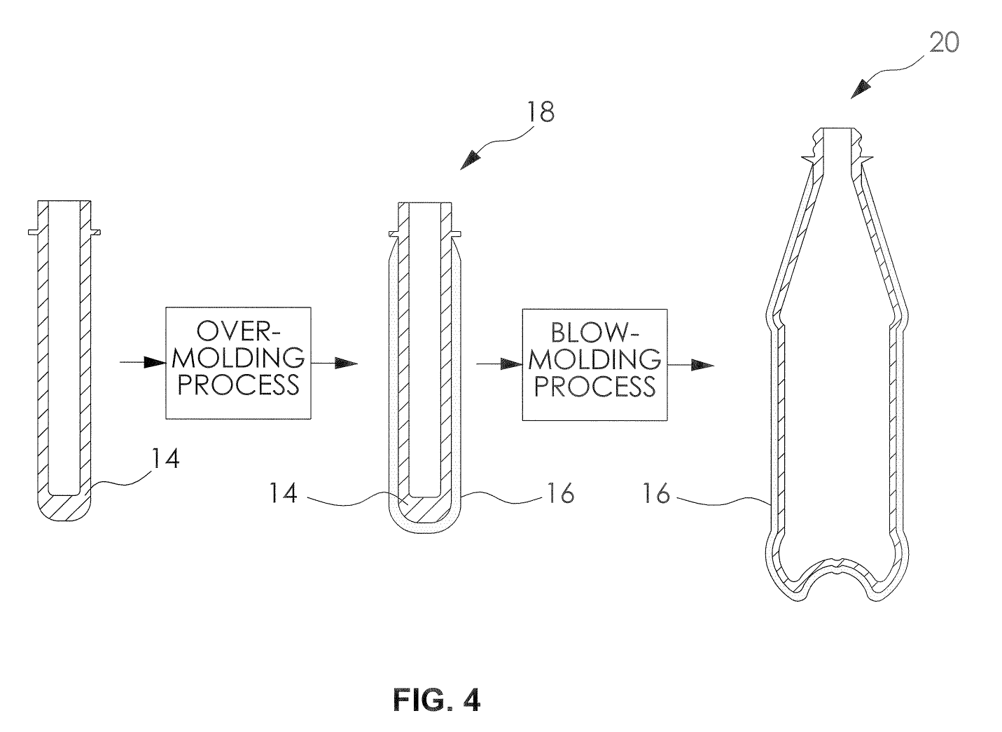

According to another embodiment of the invention, a process for preparing the overmolded preform 18 and the overmolded container 20 is schematically illustrated in FIG. 4. First, a polymer melt of the foamed material 16 of the overmolded preform 18 is prepared and then overmolded onto the preform 14. The polymer melt is formed from polymer flakes melted in a conventional plasticizing screw extruder, to prepare a homogeneous stream of hot polymer melt at the extruder discharge. Typically, the temperature of the polymer melt stream discharged from the extruder ranges from about 225 degrees Centigrade to about 325 degrees Centigrade. One ordinarily skilled in the art will appreciate that the temperature of the polymer melt stream will be determined by several factors, including the kind of polymer flakes used, the energy supplied to the extruder screw, etc. As an example, PET is conventionally extruded at a temperature from about 260 degrees Centigrade to about 290 degrees Centigrade. A non-reactive gas is injected under pressure into the extruder mixing zone, to ultimately cause the entrapment of the gas as microcellular voids within the polymer material. By the term “non-reactive gas” as it is used herein is meant a gas that is substantially inert vis-à-vis the polymer. Preferred non-reactive gases comprise carbon dioxide, nitrogen, and argon, as well as mixtures of these gases with each other or with other gasses.

The extrudate is injection molded over the preform 14 to form the overmolded preform 18 having an outer foamed layer with the non-reactive gas entrapped within the walls thereof. Methods and apparatus for injection overmolding a polymer preform are well-known in the art.

It is well-known that the density of amorphous PET is 1.335 grams per cubic centimeter. It is also known that the density of PET in the melt phase is about 1.200 grams per cubic centimeter. Thus, if the preform injection cavity is filled completely with molten PET and allowed to cool, the resulting preform would not exhibit the proper weight and would have many serious deficiencies, such as sink marks. The prior art injection molding literature teaches that, in order to offset the difference in the densities of amorphous and molten PET, a small amount of polymer material must be added to the part after the cavity has been filled and as the material is cooling. This is called the packing pressure. Thus, about ten percent more material must be added during the packing pressure phase of the injection molding cycle in order to insure that a preform made by injection molding is filled adequately and fully formed. The packing pressure phase of the injection molding operation is likewise used for polymer materials other than PET.

According to the present invention however, the preform 14 is overmolded with the polymer melt and simultaneously foamed using a non-reactive gas. The gas is entrained in the material during the injection phase. Contrary to the prior art injection molding process, wherein additional polymer material is injected during the packing phase, the present invention utilizes minimal packing pressure. As the polymer material is still in a molten state, the partial pressure of the non-reactive gas is sufficient to permit the release of the dissolved gas from the polymer into the gas phase where it forms the microcellular foam structure. Thus, the overmolded preform 18 made by the inventive process weighs less than, but has the same form and geometry as, the polymer preforms produced by the conventional injection molding operations that employ the packing process.

Upon completion of the injection molding step, the overmolded preform 18 is cooled to a temperature below the polymer softening temperature. For example, the softening temperature for PET is approximately 70 degrees Centigrade. Thus, the entrapped non-reactive gas is retained within the walls of the overmolded preform 18. This cooling step is critical to the inventive process, as it conditions the polymer and preserves its desirable properties for the successful preparation of the overmolded container 20. This cooling step is also necessary when employing polymers such as polyesters, which cannot be blow molded directly from an extruded parison. This cooling step may be effected by any conventional process used in the polymer forming art such as, for example, by passing a stream of a cooling gas over the surfaces of the overmolded preform 18, or cooling the overmolded preform 18 while in-mold by cooling the forming mold.

The overmolded preform 18 is thereafter reheated to a temperature above the polymer softening temperature. This heating step may be effected by well-known means such as, for example, by exposure of the overmolded preform 18 to a hot gas stream, by flame impingement, by exposure to infra-red energy, by passing the overmolded preform 18 through a conventional oven, or the like. PET is generally reheated to a temperature twenty to twenty-five degrees above its softening temperature for the subsequent blow molding operation. If PET is reheated too far above its glass transition temperature, or held at a temperature above its softening temperature for an excessive period of time, the PET undesirably will begin to crystallize and turn white. Likewise, if the overmolded preform 18 is heated to a temperature above which the mechanical properties of the material are exceeded by the increasing pressure of the non-reactive gas in the microcells, the microcells undesirably will begin to expand thus distorting the overmolded preform 18.

Finally, the overmolded preform 18 is blow molded, to prepare the overmolded container 20 having a non-foamed inner layer and a microcellular foamed polymer outer layer having a non-reactive gas contained within the microcellular foam cells. Methods and apparatus for blow molding a container from a polymer preform are well-known.

In addition to the preferred gases, the microcells may contain other gases typically used in processes for making microcellular foam structures. Moreover, the microcellular foam acts as an effective thermal insulator, to retard the conduct of heat energy from the atmosphere to the chilled carbonated beverage within the container.

From the forgoing description, one ordinarily skilled in the art can easily ascertain the essential characteristics of the invention, and without departing from its spirit and scope, can make various changes and modifications to adapt the invention to various uses and conditions.

I claim:

1. A blow molded container, comprising:
an inner layer of plastic suitable for blow molding; and
an outer layer of plastic suitable for blow molding contacting said inner layer, said outer layer of plastic formed as a foam wherein the foam cells contain one of carbon dioxide and nitrogen.

2. The blow molded container according to claim 1, wherein said inner layer of plastic comprises a plastic selected from the group consisting of polyesters, acrylonitrile acid esters, vinyl chlorides, polyolefins, polyamides, and derivatives, blends, and copolymers thereof.

3. The blow molded container according to claim 1, wherein said inner layer of plastic comprises polyethylene terephthalate.

4. The blow molded container according to claim 1, wherein said outer layer of plastic comprises a plastic selected from the group consisting of polyesters, acrylonitrile acid esters, vinyl chlorides, polyolefins, polyamides, and derivatives, blends, and copolymers thereof.

5. The blow molded container according to claim 1, wherein said outer layer of plastic comprises a polyester.

6. The blow molded container according to claim 1, wherein said outer layer of plastic comprises polyethylene terephthalate.

7. The blow molded container according to claim 1, wherein said outer layer of plastic and said inner layer of plastic are the same.

8. The blow molded container according to claim 1, wherein said outer layer of plastic and said inner layer of plastic are different.

9. The blow molded container according to claim 1, wherein the foam cells contain a gas comprising a gas selected from the group consisting of carbon dioxide, nitrogen, argon, air, and blends and derivatives thereof.

10. The blow molded container according to claim 1, further including a threaded portion formed at an end of the container adapted to receive a cooperating closure.

11. A multilayer preform, comprising:
a inner layer of plastic; and
an outer layer of plastic contacting said inner layer, said outer layer of plastic formed as a foam wherein the foam cells contain a gas.

12. A process for preparing a container having a foamed wall, comprising the steps of:
injection molding a polymer preform;
overmolding the polymer preform with a polymer having a non-reactive gas entrapped within the walls thereof;
cooling the preform to a temperature below the polymer softening temperature;
reheating the preform to a temperature greater than the polymer softening temperature; and
blow molding the preform, to prepare a container consisting essentially of a microcellular foamed polymer having an outer foam layer with a non-reactive gas contained within the microcellular foam cells.

13. The process for preparing a container according to claim 12, wherein the polymer comprises a polymer selected from polyesters, polypropylene, acrylonitrile acid esters, vinyl chlorides, polyolefins, polyamides, and derivatives, blends, and copolymers thereof.

14. The process for preparing a container according to claim 12, wherein the polymer comprises polyethylene terephthalate.

15. The process for preparing a container according to claim 12, wherein the non-reactive gas comprises carbon dioxide, nitrogen, argon, or a mixture thereof.

16. The process for preparing a container according to claim 12, wherein the non-reactive gas comprises carbon dioxide.

17. The process for preparing a container according to claim 12, wherein the non-reactive gas comprises carbon dioxide at a concentration of up to 10% by weight.

18. The process for preparing a container according to claim 12, wherein the polymer preform is overmolded by the polymer having a non-reactive gas entrapped within the walls thereof in a multi-step injection molding process.

19. The process for preparing a container according to claim 12, wherein the polymer preform is overmolded by the polymer having a non-reactive gas entrapped within the walls thereof in a coextrusion process.

20. The process for preparing a container according to claim 12, wherein the polymer preform is overmolded by the polymer having a non-reactive gas entrapped within the walls thereof in a coinjection molding process.
